(19) United States
(12) Patent Application Publication
(10) Pub. No.: US 2007/0173576 A1
(43) Pub. Date: Jul. 26, 2007

(54) Method for the anionic polymerization of oxirans

(75) Inventors: Philippe Desbois, Maikammer (DE); Alain Deffieux, Bordeaux (FR); Stephane Carlotti, Talence (FR); Cyrille Billouard, Bordeaux (FR)

Correspondence Address: CONNOLLY BOVE LODGE & HUTZ LLP, P.O. BOX 2207, WILMINGTON, DE, 19899-2207, US

(73) Assignee: BASF Aktiengesellschaft, Ludwigshafen (DE)

(21) Appl. No.: 10/595,637

(22) PCT Filed: Oct. 30, 2004
(86) PCT No.: PCT/EP04/12338

§ 371 Date: May 2, 2006

(30) Foreign Application Priority Data
Nov. 4, 2003 (DE) 10352105.4

(51) Int. Cl. C08K 5/41

(52) U.S. Cl. 524/167

(57) ABSTRACT

The invention relates to a process for preparation of homopolymers composed of oxiranes, or of copolymers composed of oxirans and comonomers, via anionic polymerization, which comprises carrying out a polymerization in the presence of a quaternary ammonium and/or phosphonium compound and of a mononuclear organylaluminum compound.

The invention relates to a process for preparation of homopolymers composed of oxiranes, or of copolymers composed of oxiranes and comonomers, via anionic polymerization, which comprises carrying out a polymerization in the presence of a quaternary ammonium and/or phosphonium compound and of a mononuclear organoaluminum compound.

Oxiranes are epoxides of simple structure, for example ethylene oxide (EO), also termed oxirane, and propylene oxide (PO), also termed methyloxirane. See also CD Römpp Chemie Lexikon, Version 1.0, Thieme Verlag Stuttgart, 1995 (hereinafter referred to as Römpp), keyword “Oxirane”. Particular oxirane polymers which may be mentioned are polyethylene oxide (PEO) and polypropylene oxide (PPO).

PO polymers and EO polymers may be prepared, inter alia, via anionic polymerization. Initiator systems suitable for this purpose comprise, by way of example, aluminum porphyrins as initiator and bulky Lewis acids, such as isobutylaluminum bis(2,6-di-tert-butyl-4-methylphenolate) (=iBuAl (BHT)₂, BHT=butylhydroxytoluene) as coinitiator. However, the resultant polymers are not marketable because of the low molecular weight, pronounced intrinsic color, and the expensive initiator system.

Homopolymerization reactions of PO using other initiator systems are described in the following publications:

Ding et al., in Eur. Pol. J. 1991, 27, 891-894 and Eur. Pol. J, 1991, 27, 895-899, teach the anionic polymerization of PO by means of the potassium salt of 1-methoxy-2-propanol and a crown ether, such as 18-crown-6. The resultant PO homopolymers had number-average molecular weights of from about 3000 to 13 000.

JP-A 2000/086755 discloses an initiator composition composed of an alkali metal alkoxide (e.g. potassium tert-butanolate) or of an alkali metal hydroxide, of an organic Lewis acid, e.g. CH₃Al(BHT)₂, and of a crown ether, e.g. 18-crown-6. At 48 hours of reaction time, the number-average molecular weights (Mn) of the PPO are at most about 8000.

JP-A 2000/256457 teaches a similar initiator composition composed of an alkali metal alkoxide or alkali metal hydroxide, of a crown ether, and of specific organic Lewis acids, which have direct metal-carbon bonds without oxygen bridges. The number-average molecular weights of the PPO after from 5 to 25 hours of reaction time are at most about 10 000.

JP-A 2002/128886 discloses a similar initiator composition composed of an alkali metal alkoxide or alkali metal hydroxide, of a crown ether, of a trialkylaluminum compound, and of a polyether polyol. After 3 and, respectively, 6 days of polymerization time, the number-average molecular weights of the PPO are about 25 000 and about 18 000.

If, alongside the oxirane, use is made of another anionically polymerizable monomer, e.g. styrene, it is also possible to prepare oxirane copolymers, in particular block copolymers. Quirk et al., in Macromol. Chem. Phys. 2000, 201, 1395-1404, pp. 1396-1397, describe the preparation of polystyrene-PO block copolymers, by first using sec-butyllithium for the anionic polymerization of styrene. The polystyrene block is then functionalized using EO, and a PPO block is finally polymerized from PO onto the material in the presence of potassium tert-amylate and dimethyl sulfoxide (DMSO). The reaction time is 7 days, and the number-average molecular weight of the block copolymer is about 5000.

Quirk et al., in Polym. Int. 1996, 39, 3-10, teach the preparation of polystyrene-EO block copolymers by a similar process, the potassium salt used being potassium tert-butanolate, potassium tert-amylate, or potassium di-tert-2,6-phenolate. After from 1 to 6 days of reaction time, block copolymers with number-average molecular weights of at most 19 000 were obtained.

The processes described for preparing homo- or copolymers of PO or of EO have very long polymerization times (two or more days) and/or the resultant molecular weights are unsatisfactorily low. They are therefore not cost-effective.

Ihara et al., in Macromolecules 2002, 35 No. 11, 4223-4225, teach that tert-butyl acrylate, but not n-butyl acrylate or methyl methacrylate (MMA), can be polymerized anionically in the presence of an initiator system composed of potassium tert-butylate and trialkylaluminum compounds, such as triisobutylaluminum (TIBA), to give the homopolymer. However, it is possible to polymerize a poly-MMA block onto a poly-tert-butyl acrylate block. No mention is made of oxiranes as monomers.

In Angew. Chem. Int. Ed. 2003, 42 No. 1, 64-68, Braune and Okuda describe the polymerization of PO using mixtures of specific aluminum complexes. In a multistage synthesis, neutral aluminum complexes [Al(L)Cl]₂ and [Al(L)OiPr]₂ are first prepared and isolated, these being binuclear—i.e. comprising two Al atoms per molecule. These binuclear complexes are reacted with NEt₄-Cl or NEt₄-OiPr to give anionic complexes [NEt₄][Al(L)Cl₂] and, respectively, [NEt₄][Al(L)(OiPr)₂], and these are likewise isolated. L here is 2,2′-methylenebis(6-tert-butyl-4-methylphenol) or 2,2′-methylenebis[4-methyl-6-(1-methylcyclohexyl)phenol], OiPr is isopropanolate, and Et is ethyl. It is said that PO can only be polymerized if the neutral (binuclear) and anionic complexes are used together. The preparation and isolation of the complex compounds mentioned is complicated and costly, and after 3 hours of reaction time the number-average molecular weight of the PPO is only from about 1100 to at most 3600.

The earlier DE application number 10323047.5 of May 20, 2003, which is not a prior publication, discloses a process for preparation of oxirane homo- or copolymers via anionic polymerization by means of an alkali metal compound and of an organoaluminum compound, but without crown ethers or cryptands.

It is an object of the present invention to eliminate the disadvantages described. A particular object is to provide another process for polymerizing oxiranes. The process should have economic advantages over the known processes.

The polymerization times should be markedly shorter than those in the prior-art processes, the desired polymerization time being at most 48 hours. This shorter time should not result in achievement of poorer molecular weight. Furthermore, the process should be capable of achieving polyoxiranes with higher molecular weights than those of the prior art.

A further object consists in providing a process which can prepare not only homopolymers but also copolymers. Oxiranes are highly reactive compounds, and the process should permit improved monitoring and simpler control of the oxirane polymerization process.

Finally, the process should be simpler than the processes of the prior art, in particular requiring fewer reagents. In particular, the initiators used, or initiator systems and their components, should be simpler than those of the prior art, and should be easy to prepare.

Accordingly, the process defined at the outset has been found, as also have the homo- and copolymers mentioned, the use mentioned of these, and the moldings, foils, fibers, and foams mentioned. Preferred embodiments of the invention are given in the subclaims.

The process of the invention polymerizes oxiranes via anionic polymerization to give homopolymers, or polymerizes oxiranes and comonomers via anionic polymerization to give copolymers. The polymerization takes place in the presence of a quaternary ammonium and/or phosphonium compound and of a mononuclear organylaluminum compound.

Suitable oxiranes are any of the epoxides of simple structure (i.e. without condensed ring systems). The oxiranes are preferably those selected from propylene oxide (PO), ethylene oxide (EO), and mixtures of these.

PO-EO copolymers are obtained if more than one oxirane is used together, in this case by way of example PO and EO. It has been found that PO/EO mixtures polymerize in a manner similar to that of pure PO. This similar polymerization behavior means that some of the PO may be replaced by EO without any requirement for substantial change in the polymerization conditions (process parameters). This has economic advantages, because there is no need for complicated process adaptation measures. In addition, EO is generally less expensive than PO.

Suitable mixtures of PO and EO usually have an EO proportion of from 0.1 to 99.9% by weight, particularly from 10 to 90% by weight, and particularly preferably from 20 to 80% by weight, based on the mixture.

Comonomers which may be used to prepare the copolymers are any of the anionically polymerizable monomers, in particular styrene monomers and diene monomers. Suitable styrene monomers are any of the vinylaromatic monomers, for example styrene, α-methylstyrene, p-methylstyrene, ethylstyrene, tert-butylstyrene, vinylstyrene, vinyltoluene, 1,2-diphenylethylene, 1,1-diphenylethylene, or a mixture of these. Diene monomers which may be used are any of the polymerizable dienes, in particular 1,3-butadiene (abbreviated to butadiene), 1,3-pentadiene, 1,3-hexadiene, 2,3-dimethylbutadiene, isoprene, piperylene, or a mixture of these.

The comonomers have preferably been selected from styrene, α-methylstyrene, butadiene, isoprene, and mixtures of these. Styrene is particularly preferred.

If concomitant use is made of comonomers, i.e. if copolymers are prepared, the proportion of the comonomers is from 0.1 to 99.9% by weight, preferably from 0.1 to 80% by weight, and in particular from 0.1 to 50% by weight, based on the entire amount of monomer. Further details concerning the copolymers, in particular block copolymers, are given at a later stage below.

Quaternary ammonium compounds are ammonium compounds where all four of the H atoms of the NH₄⁺ ion have been replaced by organic radicals R. They preferably have the general formula I
R¹R²R³R⁴N—X (I)
where the radicals R¹, R², R³, and R⁴ may be identical or different. Formula I may also be simplified to formula Ia
NR₄—X (Ia)
where
R¹, R², R³, R⁴, or, respectively, R: are identical or different alkyl radicals, aryl radicals, or alkylaryl radicals having from 1 to 20 carbon atoms, which may be unsubstituted or substituted radicals, and which may comprise O, S, N, P, Si, halogen, or comprise other heteroatoms, and
X: is an inorganic or organic radical, for example an inorganic group such as halogen, cyanide, hydroxide or hydrogencarbonate, or an organic group, such as alcoholate(alkoxide), amine or alkylamine, or carboxylic acid radicals, such as formate, acetate, or propionate.

R¹, R², R³, and R⁴, or, respectively, R are preferably identical or different alkyl having from 1 to 10 carbon atoms, and X is preferably halogen, OH, or an alcoholate radical having from 1 to 10 carbon atoms. R is particularly preferably identical radicals, i.e. R¹=R²=R³=R⁴. R is particularly preferably ethyl (Et) or n-butyl (nBu), and X is particularly preferably Cl, OH, acetate, or isopropanolate (OiPr).

Particularly preferred quaternary ammonium compounds are tetraethylammonium isopropanolate NEt₄-OiPr, tetra-n-butylammonium isopropanolate NnBu₄-OiPr, tetra-n-butylammonium chloride NnBu₄-Cl, tetra-n-butylammonium hydroxide NnBu₄-OH, and tetra-n-butylammonium acetate NnBu₄-OOC(CH₃).

Correspondingly, phosphonium compounds are salts in which all four of the H atoms of the PH₄⁺ ion have been replaced by organic radicals R. They preferably have the general formula I
R¹R²R³R⁴P—X (I)
where the radicals R¹, R², R³, and R⁴ may be identical or different. Formula I may also be simplified to formula Ib
PR₄—X (Ib)

R¹ to R⁴ being defined as for the ammonium compounds Ia.

Particularly preferred quaternary phosphonium compounds are tetraethylphosphonium isopropanolate PEt₄-OiPr, tetra-n-butylphosphonium isopropanolate PnBu₄-OiPr, tetra-n-butylphosphonium chloride PnBu₄-Cl, tetra-n-butylphosphonium hydroxide PnBu₄-OH, and tetra-n-butylphosphonium acetate PnBu₄-OOC(CH₃).

The quaternary ammonium and phosphonium compounds are commercially available, or can be prepared by a simple method known per se. For example, the isopropanolates can be prepared from the corresponding commercially available halides via reaction with isopropanol.

The amount of quaternary ammonium and/or phosphonium compound needed depends inter alia on the desired molecular weight (molar mass) of the polymer that is to be prepared, on the nature and amount of the organoaluminum compound used, and of coinitiator, if appropriate (see below), and on the polymerization temperature. The amount used is generally from 0.001 to 10 mol %, preferably from 0.01 to 1 mol %, and particularly preferably from 0.02 to 0.2 mol %, of quaternary ammonium and/or phosphonium compound, based on the total amount of the monomers used.

It is likely that the organoaluminum compounds act as activator for the oxirane monomer. The organoaluminum compound possibly interacts with its epoxy group, opening the epoxide ring and thus permitting polymerization of the oxirane. This assumed mechanism differs fundamentally from that of anionic polymerization of styrene or butadiene, where the organoaluminum compound is what is known as a retarder, reducing polymerization rate.

Organyl compounds are the organometallic compounds of a metal having at least one metal-carbon σ-bond, in particular the alkyl or aryl compounds. The organyl metal compounds can also comprise hydrogen or halogen, or can comprise organic radicals bonded by way of heteroatoms, examples being alcoholates or phenolates, on the metal. By way of example, the latter are obtainable via complete or partial hydrolysis, alcoholysis, or aminolysis.

According to the invention, mononuclear organoaluminum compounds are used, these being those which comprise one aluminum atom per molecule (formula unit), contrasting with polynuclear organyl compounds which have two or more aluminum atoms in the molecule. By way of example, noninventive, binuclear organoaluminum compounds are used in the prior art mentioned of Braune and Okuda.

Organoaluminum compounds which may in particular be used are those of the formula R₃—Al, where the radicals R are, independently of one another, hydrogen, halogen, C₁₋₂₀-alkyl, C₆₋₂₀-aryl, or C₇₋₂₀-arylalkyl. Trialkylaluminum compounds are preferably used as organoaluminum compounds.

The alkyl radicals may be identical, as, for example, in trimethylaluminum (TMA), triethylaluminum (TEA), triisobutylaluminum (TIBA), tri-n-butylaluminum, triisopropylaluminum, tri-n-hexylaluminum, or different, as, for example, in ethyldiisobutylaluminum. It is also possible to use dialkylaluminum compounds, such as diisobutylaluminum hydride (DiBAH). TEA or TIBA is particularly preferably used as organoaluminum compound, very particular preference being given to TIBA.

Other organoaluminum compounds which may be used are those formed by partial or complete reaction of alkyl-, arylalkyl-, or arylaluminum compounds with water (hydrolysis), with alcohols (alcoholysis), with amines (aminolysis), or with oxygen (oxidation), or those which bear alcoholate, thiolate, amide, imide or phosphite groups. Hydrolysis gives aluminoxanes. Examples of suitable aluminoxanes are methylaluminoxane, isobutylated methylaluminoxane, and isobutylaluminoxane.

Alcoholysis gives aluminum alcoholates, also termed aluminum alkoxides (e.g. . . . propanolate= . . . propoxide). Examples of suitable alcoholates are dimethylaluminum ethanolate, diethylaluminum ethanolate, dimethylaluminum isopropanolate, dimethylaluminum n-butanolate, diisobutylaluminum ethanolate, diisobutylaluminum isopropanolate, diisobutylaluminum n-butanolate. Other suitable alcoholates are those of 2,6-di-tert-butyl-4-methylphenol, also termed butylhydroxytoluene (BHT), examples being methylaluminum bis(2,6-di-tert-butyl-4-methylphenolate) (=Me-Al-(BHT)₂), isobutylaluminum bis(2,6-di-tert-butyl-4-methylphenolate) (=iBu-Al-(BHT)₂), and diisobutylaluminum (2,6-di-tert-butyl-4-methylphenolate (=(iBu)₂⁻Al-BHT, CAS-No. 56252-56-3).

An example of a suitable aluminum amide is diethylaluminum N,N-dibutylamide. Oxidation gives aluminum oxides, such as bis(diisobutyl)aluminum oxide.

Depending on the molar ratio of alkylaluminum compound R₃—Al to alcohol R′OH, one, two or all three, of the alkyl groups of the alkylaluminum compound are replaced by an alcoholate group (alkoxide group) during the alcoholysis reaction. Mixtures of various alcoholates R₂—Al—OR′, R—Al—(OR′)₂ and Al—(OR′)₃ may also arise. The same principle applies to arylaluminum or arylalkylaluminum compounds, and for reaction partners other than alcohol. For example, reaction of two different alkylaluminum compounds R₃—Al and R′₃—Al gives compounds R₂—Al—R′ and R—Al—R′₂.

Reaction of alkylaluminum compounds with polyhydric alcohols, such as dialcohols, can give alcoholates having two or more Al atoms. For example, reaction of TIBA with 1,4-butanediol (HO-nBu-OH) gives an aluminum alcoholate iBu-Al—O-nBu-O—Al-iBu, which may be used with preference.

Me is methyl, nBu is n-butyl, and iBu is isobutyl.

The amount needed of organoaluminum compound depends inter alia on the nature and amount of the monomer used, on the desired molecular weight (molar mass) of the polymer to be prepared, on the nature and amount of the quaternary ammonium and/or phosphonium compound and, if appropriate, coinitiator used (see below), and on the polymerization temperature. The amount used is generally from 0.01 to 10 mol %, preferably from 0.5 to 1 mol %, of organoaluminum compound, based on the total amount of the monomers used.

From the above it is apparent that it is also possible to use mixtures of various quaternary ammonium and/or phosphonium compounds and, respectively, organoaluminum compounds.

The molar ratio of quaternary ammonium and/or phosphonium compound to organoaluminum compound can vary within wide limits. By way of example, it depends on the polymerization rate, on the polymerization temperature, on the nature and amount (concentration) of the monomers used, and on the desired molecular weight of the polymer. The amounts of quaternary ammonium and/or phosphonium compound and organoaluminum compound are preferably selected in such a way that from 1 to 100 mol of organoaluminum compound are present in the reaction mixture per mole of ammonium and/or phosphonium compound, meaning that the molar ratio of organylaluminum to quaternary ammonium and/or phosphonium compound, calculated as aluminum atoms to ammonium nitrogen atoms and, respectively, phosphonium phosphorus atoms is preferably from 1:1 to 100:1. The molar ratio of organoaluminum compound to ammonium and/or phosphonium compound is particularly preferably from 2:1 to 50:1, in particular from 4:1 to 10:1. By way of example, operations can be carried out with a ratio of about 5:1. The molar ratio of organoaluminum compound to phosphonium compound is particularly preferably from 1.1:1 to 10:1. By way of example, operations can be carried out with a ratio of about 5:1.

In one preferred embodiment, a coinitiator is used in addition to the quaternary ammonium and/or phosphonium compound and to the organoaluminum compound. By way of example, this can be advantageous if a trialkylaluminum compound, such as TIBA or TEA, is used as organoaluminum compound. The coinitiator probably activates the quaternary ammonium and/or phosphonium compound.

Preferred suitable coinitiators are the organoaluminum compounds described above, e.g. those of the formula R¹R²R³Al, where R¹, R² and R³, independently of one another, are hydrogen, halogen, C₁₋₂₀-alkyl, C₆₋₂₀-aryl or C₇₋₂₀-arylalkyl. At least two of the radicals R¹, R² and R³ here can differ from one another. By way of example, alkylaluminum hydrides R—Al—H₂ and R₂—Al—H are suitable, e.g. diisobutylaluminum hydride iBu₂-AlH, and also the abovementioned compounds Me-Al-(BHT)₂, (=iBu-Al-(BHT)₂), and (iBu)₂-Al-BHT, CAS No. 56252-56-3. It is also possible to use alkylaluminum halides R—Al-Hal₂ and R₂—Al-Hal (Hal=halogen), e.g. diethylaluminum chloride Et₂-Al—Cl. Organoaluminum compounds having three identical radicals comprising heteroatoms are also suitable, examples being aluminum trialcoholates, such as aluminum tri-n-butanolate (nBuO)₃-Al.

Concomitant use of a coinitiator is possible but not essential. If coinitiator is used concomitantly, the amount needed depends inter alia on the desired molecular weight (molar mass) of the polymer to be prepared, on the nature and amount of the organoaluminum compound used and of the quaternary ammonium and/or phosphonium compound, and on the polymerization temperature. The amount used is generally from 0.005 to 10 mol %, preferably from 0.01 to 10 mol %, and particularly preferably from 0.5 to 1 mol %, of coinitiator, based on the total amount of the monomers used.

The molar ratio of quaternary ammonium and/or phosphonium compound to coinitiator, if the latter is used concomitantly, can vary. By way of example, it depends on the polymerization rate, on the polymerization temperature, on the nature and amount (concentration) of the monomers used, and on the desired molecular weight of the polymer. The amounts of coinitiator are preferably selected in such a way that from 0.01 to 10 mol of coinitiator are present in the reaction mixture per mole of ammonium and/or phosphonium compound, meaning that the molar ratio of coinitiator to quaternary ammonium and/or phosphonium compound, calculated as aluminum atoms to nitrogen atoms and, respectively, phosphorus atoms, is preferably from 0.01:1 to 10:1. The molar ratio of coinitiator to ammonium and/or phosphonium compound is particularly preferably from 0.1:1 to 5:1, in particular from 0.5:1 to 2:1. By way of example, operations can be carried out with a ratio of about 1:1.

Quaternary ammonium and/or phosphonium compound, organoaluminum compound and, if appropriate, the coinitiator may be added in undiluted form or—preferably—in solution or dispersion (emulsified or suspended) in a solvent and, respectively, dispersion medium. This solvent and, respectively, dispersion medium can be—but does not have to be—identical with the solvent used during the polymerization reaction, see below.

Ammonium and/or phosphonium compound, organoaluminum compound and, if appropriate, coinitiator can be added together or separately, in both chronological and spatial terms, batchwise all at once or in two or more portions, or else continuously. Separate addition is preferred.

The coinitiator is preferably added together with or after the quaternary ammonium and/or phosphonium compound, and prior to the organoaluminum compound (or before most of the organoaluminum compound is added). It is assumed that it activates the quaternary ammonium and/or phosphonium compound.

In one preferred embodiment without coinitiator, the sequence of addition is 1) monomer, 2) quaternary ammonium and/or phosphonium compound, 3) organoaluminum compound. This means that the quaternary ammonium and/or phosphonium compound is first added to the reaction mixture comprising the oxirane monomers and, if appropriate, comprising comonomers, and then the organoaluminum compound is added to the mixture. 1) and 2) can also be swapped, meaning that ammonium and/or phosphonium compound can be used as initial charge and monomer can be added, as long as only the organoaluminum compound is added after the ammonium and/or phosphonium compound.

If a coinitiator is used concomitantly, the sequence of addition is preferably 1) ammonium and/or phosphonium compound+coinitiator, 2) monomer, 3) organoaluminum compound. This means that it is preferable to use a mixture of quaternary ammonium and/or phosphonium compound and coinitiator as initial charge, to add the monomer(s), and then to add the organoaluminum compound. 1) and 2) can also be swapped, meaning that monomer can be used as initial charge and ammonium and/or phosphonium compound and coinitiator can be added. To prepare the mixture of ammonium and/or phosphonium compound and coinitiator, by way of example, the two components can be used together as initial charge, or the ammonium and/or phosphonium compound can first be used as initial charge and the coinitiator can be added.

In the inventive process it is therefore preferable to begin by adding the quaternary ammonium and/or phosphonium compound and then to add the organoaluminum compound to the mixture.

During the polymerization reaction, concomitant use may be made of amine compounds which form a chelate, complexing the alkali metal atom. Use may in particular be made of tertiary amine compounds, such as N,N,N′,N′-tetramethylmethylenediamine (TMMDA), N,N,N′,N′-tetramethylethylenediamine (TMEDA), N,N,N′,N′-tetramethylpropylenediamine (TMPDA), N,N,N′,N′-tetramethylhexenediamine (TMHDA), and other N,N,N′,N′-tetraalkyldiamines, and also diazabicyclo[2.2.2]octane (DABCO). Among other suitable amines is pentamethyidiethylenetriamine.

It is possible to use crown ethers and cryptands in the polymerization reaction. However, they are preferably not used. Crown ethers are macrocyclic polyethers of planar structure. By way of example, they have ethylene bridges bonding their oxygen atoms. The term crown ethers also applies to those whose oxygen atoms have been completely or partially replaced by heteroatoms, such as N, P or S, and spherands, e.g. isocyclic carbon rings which bear —OH or bear other polar groups, all of which have identical orientation into the interior of a cavity. Cryptands are macropolycyclic azapolyethers related to the crown ethers and having two bridgehead nitrogen atoms bonded by bridges comprising one or more oxygen atoms. For further details, see Römpp, keywords “Kronenether”[Crown ethers] and “Kryptanden”[Cryptands]. The addition of crown ethers or, respectively, of cryptands as either reagent or as ancillary material (e.g. solvent) is not preferred.

The omission of these (expensive) compounds makes the inventive process not only simpler than the prior-art processes but also more cost-effective in operation.

The polymerization reaction may be carried out in the absence of or—preferably—in the presence of a solvent. It is preferable for the solvent used to be nonpolar and to comprise no oxygen atoms or other heteroatoms which increase polarity. The polymerization reaction particularly preferably takes place in an aliphatic, isocyclic, or aromatic hydrocarbon or hydrocarbon mixture, for example benzene, toluene, ethylbenzene, xylene, cumene, hexane, heptane, octane, or cyclohexane. It is preferable to use solvents whose boiling point is above 70° C. It is particularly preferable to use heptane, toluene, or cyclohexane.

Once the polymerization reaction has ended, i.e. once the monomers have been consumed, it is terminated. During the polymerization reaction, and also after its termination, i.e. also after the monomers have been consumed, there are “living” polymer chains in the reaction mixture, and this means that the polymerization reaction immediately restarts on renewed addition of monomer, with no need for further addition of polymerization initiator. The reaction is finally terminated by adding a chain terminator. This terminator irreversibly terminates the living polymer chain ends.

Terminators which may be used are any of the protic substances, and Lewis acids. By way of example, water is suitable, as are C₁-C₁₀ alcohols, such as methanol, ethanol, isopropanol, n-propanol, and the butanols. Other suitable compounds are aliphatic and aromatic carboxylic acids, such as 2-ethylhexanoic acid, and also phenols. It is also possible to use inorganic acids, such as carbonic acid (solution of CO₂ in water) and boric acid. Ethanol is preferably used as terminator.

The resultant reaction mixture may, if desired, then be worked up in a known manner to give the polymer, e.g. by means of devolatilization in a vented extruder or evaporator. The devolatilization removes oligomers which have formed and residual monomers, and also removes volatile auxiliaries and ancillary materials used during the polymerization reaction, and in particular the solvent.

The other polymerization conditions, such as pressure and temperature, depend, inter alia, on the reactivity and concentration of the monomers, on the ammonium compounds, phosphonium compounds and aluminum compounds used, and on their concentrations. Operations are usually carried out at an absolute pressure of from 0.1 to 50 bar, in particular from 0.5 to 10 bar, and at a reaction temperature from −50 to 200° C., in particular from −30 to 100° C., and particularly preferably from −10 to 80° C. Low temperatures permit better control of the reaction, but the polymerization time is longer. The polymerization reaction usually takes from 5 min to 48 hours, in particular from 10 min to 12 hours.

The inventive process for preparing the polymers may be carried out batchwise or continuously, in any conventional container or reactor, and in principle it is possible to use either back-mixing or non-back-mixing reactors (i.e. reactors with stirred-tank characteristics or tubular-reactor characteristics). Depending on the selection of the alkali metal compound and of the organoaluminum compound, and of the concentrations of these, and of the specific procedure used (e.g. sequence of addition), and of other parameters, such as polymerization time and polymerization temperature and, if appropriate, temperature profile, the process gives polymers of various molecular weight. By way of example, stirred tanks are suitable, as are tower reactors, loop reactors, and also tubular reactors or tube-bundle reactors, with or without internals. Internals may be static or movable internals.

Besides the polymerization process described above, the invention also provides the polymers obtainable by the polymerization process, i.e. homopolymers of oxiranes, or copolymers of oxiranes and comonomers, or a mixture of these.

These oxirane homopolymers are in particular polyethylene oxide and polypropylene oxide. The number-average molar mass Mn of the polyethylene oxide (PEO) or polypropylene oxide (PPO) obtained is in each case preferably from 1000 to 1 000 000 g/mol, in particular from 5000 to 500 000 g/mol, and particularly preferably from 10 000 to 200 000 g/mol.

The copolymers obtained may have a random structure, meaning that the sequence of the monomer units in the copolymer is entirely random, or an alternating structure (where oxirane units and comonomer units alternate). They may also have a tapered structure. The term “tapered” means that a gradient from oxirane-rich to oxirane-poor or vice versa is present along the polymer chain.

However, the copolymers preferably have block structure, and are therefore block copolymers. The structure of the block copolymers is preferably composed of at least one block of the oxirane(s), and of at least one block of the comonomer(s). The inventive block copolymers may, by way of example, be linear A-B two-block copolymers or B-A-B or A-B-A three-block copolymers. A here is the polyoxirane block and B here is the block composed of comonomer(s). For styrene as preferred comonomer, B is therefore a polystyrene block.

The block structure arises in essence because the comonomer is first anionically polymerized alone, producing a “living” block composed of the comonomer. Once the comonomer has been consumed, the monomer is changed by adding monomeric oxirane and polymerizing anionically to give an oxirane block, meaning that a polyoxirane block is polymerized onto the living comonomer block. By way of example, styrene may first be polymerized alone to give a polystyrene block PS. Once the styrene has been consumed, the monomer is changed by adding propylene oxide, which then is polymerized to give the polypropylene oxide block PPO. The result of this polymerization, known as sequential polymerizaiton, is a two-block polymer B-A, e.g. PS-PPO.

It is also possible to begin by preparing the polyoxirane block A and then to polymerize, onto this, the block B composed of the comonomer(s). However, it is preferable to polymerize the comonomer block B first and then the polyoxirane block A, for example the polystyrene block first and then the PPO block.

The invention therefore also provides a process wherein the copolymers are block copolymers, and sequential polymerization is first used to polymerize the comonomer to give a polymer block B, and then the oxirane is polymerized to give a polyoxirane block A.

From the two-block polymers, it is possible to prepare three-block copolymers via coupling, using another living polymer block. For this, a living polymer block is first prepared separately and then coupled to the two-block copolymer, using a coupling agent (see below). Three-block copolymers may also be prepared by means of a telechelic middle block. For example, two terminal PPO blocks may be polymerized onto a telechelic polystyrene block, giving a three-block copolymer PPO-PS-PPO. The two comonomer blocks (e.g. polystyrene blocks) in the three-block copolymers may be of equal size (equal molecular weight, i.e. symmetrical structure) or be of different size (different molecular weight, i.e. asymmetric structure). The block sizes depend, by way of example, on the amounts of monomer used and the polymerization conditions.

In one preferred embodiment, an alkali metal compound is used concomitantly to prepare the block copolymers. It acts as polymerization initiator. Particularly suitable alkali metal compounds are alkali metal organyl compounds or alkali metal hydrides, or a mixture of these. Examples of alkali metal organyl compounds that can be used are mono-, bi-, or polyfunctional alkali metal alkyl, aryl, or aralkyl compounds, in particular organolithium compounds, such as ethyl-, propyl-, isopropyl-, n-butyl-, sec-butyl-, tert-butyl-, phenyl-, diphenylhexyl-, hexamethylenedi-, butadienyl-, isoprenyl-, or polystyryllithium, or the polyfunctional compounds 1,4-dilithiobutane, 1,4-dilithio-2-butene or 1,4-dilithiobenzene. It is preferable to use sec-butyllithium. Examples of suitable alkali metal hydrides are lithium hydride, sodium hydride, or potassium hydride.

The amount needed of alkali metal compound depends inter alia on the desired molecular weight (molar mass) of the polymer to be prepared, on the nature and amount of the retarder used, and on the polymerization temperature. The amount used is generally from 0.0001 to 10 mol %, preferably from 0.001 to 1 mol % and particularly preferably from 0.01 to 0.2 mol %, of alkali metal organyl compound, based on the total amount of the monomers used.

Preparation of the alkali metal compounds is known, or the compounds are available commercially.

The alkali metal compound is preferably used concomitantly in polymerization of the polymer block B (comonomer block). Not only the alkali metal compound but also the organoaluminum compound and the ammonium and/or phosphonium compound here 20 can be added before polymerization of the first block is complete. However, for example if—as is preferred—the comonomer block B (e.g. a polystyrene block) is prepared first and then the polyoxirane block A is prepared, the comonomer block can be polymerized in the presence of the alkali metal compound (i.e. without organoaluminum compound), and addition of the organoaluminum compound and of the ammonium and/or phosphonium compound can be delayed until polymerization of the polyoxirane block takes place.

By way of example, it is possible to begin by preparing the polystyrene block from styrene by means of alkali metal compound (e.g. sec-butyllithium), and to delay addition of the organoaluminum compound (e.g. TIBA) and of the ammonium and/or phosphonium compound (e.g. NnBu₄-Cl) until addition of the oxirane monomer takes place, and polymerize the mixture to give the polyoxirane block.

It is particularly preferable that—after preparation of the comonomer block—the oxirane monomer and the ammonium and/or phosphonium compound are first added to the mixture, and that the organoaluminum compound is added after initiation of the reaction.

The block copolymers mentioned may have a linear structure (as described above). However, branched or star structures are also possible and are preferred for some applications. Branched block copolymers are obtained in a known manner, e.g. via graft reactions of polymeric “branches” onto a main polymer chain. Star block copolymers are obtainable, by way of example, via reaction of the living anionic chain ends with an at least bifunctional coupling agent, for example epoxidized glycerides (e.g. epoxidized linseed oil or soy oil), silicon halides, such as SiCl₄, or else divinylbenzene, or else polyfunctional aldehydes, ketones, esters, anhydrides, or epoxides, or, specifically for dimerization, dichlorodialkylsilanes, dialdehydes, such as terephthalaldehyde, and esters, such as ethyl formate. Symmetrical or asymmetric star structures can be prepared via coupling of identical or different polymer chains, and this means that the individual arms of the star may be identical or different.

The inventive polymers may also comprise conventional additives and processing aids, the amounts being those usual for these substances, examples being lubricants, mold-release agents, colorants, e.g. pigments or dyes, flame retardants, antioxidants, light stabilizers, fibrous or pulverulent fillers, fibrous or pulverulent reinforcing agents, and antistatic agents, and also other additives and mixtures of these.

The molding compositions may be prepared by mixing processes known per se, for example with melting in an extruder, Banbury mixer, or kneader, or on a roll mill or calender. However, the components may also be used “cold”, and the melting and homogenization of the mixture, composed of powder or of pellets, may be delayed until processing has begun.

The inventive homo- and copolymers may be used to produce moldings (or semifinished products), foils, fibers, or foams of any type.

The invention accordingly also provides for the use of the inventive homo- or copolymers for producing moldings, foils, fibers and foams and also the moldings, foils, fibers and foams obtainable from the polymers.

The inventive process is an alternative process for the polymerization of oxiranes, and, when compared with the prior-art processes, has, inter alia, economic advantages. The polymerization times are markedly shorter than in the processes known hitherto. At the same time, despite the shorter polymerization time, the molar masses achieved are higher, for example as shown in inventive example H8 with an Mn of 86 600 g/mol after only 45 min.

The initiator systems used or their components are simpler than those of the prior art.

The process permits preparation of homo- and copolymers in an equally simple manner. The polymers obtained feature low contents of residual monomers or residual oligomers. Furthermore, PO homopolymers and PO-EO copolymers can be prepared under similar process conditions, and this is economically advantageous because EO is less expensive.

The inventive process permits better monitoring of the oxirane polymerization process, meaning that polymerization of the reactive oxiranes is easy to control.

### EXAMPLES

1. Starting Materials

The compounds mentioned under 1a, 1b and 1c were used, and “purified” means that aluminoxane was used for purification and drying unless otherwise stated. Commercially available products were used without further purification.

1a. Monomers, Solvents, and Auxiliaries
styrene, purified
propylene oxide (PO), purified via treatment with calcium hydride
cyclohexane, purified
toluene, purified
tetrahydrofuran (THF), purified via distillation
ethanol or water (as terminator).

1b. Quaternary Ammonium Compounds, Organoaluminum Compounds, and Alkali Metal Compounds

All of the following dilution or reaction processes were undertaken with stirring at 25° C. and under inert gas, unless otherwise stated. The following solutions or solids were used:
#1: Triisobutylaluminum (TIBA) iBu₃-Al, in the form of 1.0-molar solution:
   A ready-to-use solution in toluene (from Aldrich) was used.
#2: Triethylaluminum (TEA) Et₃-Al, in the form of 1.0-molar solution:
   A 1.9-molar triethylaluminum solution in toluene (ready-to-use solution from Aldrich) was diluted with toluene to a concentration of 1 mol/l.
#3: Tetra-n-butylammonium isopropanolate NnBu₄-iPr in solid form:
   0.954 g (3.43 mmol) of tetra-n-butylammonium chloride hydrate NnBu₄-Cl.H₂O (98%, solid from Aldrich) was treated with 3 ml of isopropanol (99%, Aldrich). Once all of the solid had dissolved, the isopropanol was removed via cryodistillation. Addition and removal of isopropanol was repeated 3 more times. Isopropanol was then added to dissolve the NnBu₄-Cl, which by now was anhydrous, and 3 ml of THF were added. 2.5 ml of a 1.35-molar solution of sodium isopropanolate in THF were then added to the mixture. After 1 hour, the mixture was filtered off from the resultant white NaCl precipitate. This gave a solution of NnBu₄-OiPr in THF/isopropanol, from which the solvent mixture was removed via cryodistillation. This gave NnBu₄-OiPr in solid form.
#4: Tetraethylammonium isopropanolate NEt₄-OiPr in solid form:
   The procedure was as described for NnBu₄-OiPr (#3), but 0.568 g (3.43 mmol) of tetraethylammonium chloride hydrate NEt₄-Cl.H₂O (98%, solid from Aldrich) was used instead of NnBu₄-Cl hydrate. This gave NEt₄-OiPr in solid form.
#5: Tetra-n-butylammonium chloride NnBu₄-Cl in solid form:
   0.55 g (1.98 mmol) of tetra-n-butylammonium chloride hydrate NnBu₄-Cl.H₂O (solid from Aldrich) was treated with 3 ml of isopropanol (99%, Aldrich). Once all of the solid had dissolved, the isopropanol was removed via cryodistillation. Addition and removal of isopropanol was repeated 3 more times. This gave anhydrous NnBu₄-Cl in solid form.
#6: Tetra-n-butylammonium hydroxide NnBu₄-OH in solid form:
   A 1.0-molar solution of tetra-n-butylammonium hydroxide NnBu₄-OH in methanol (ready-to-use solution from Aldrich) was used to isolate the solid via cryodistillation of the methanol, and the anhydrous material was then prepared via treatment with isopropanol as described for NnBu₄-Cl (#5).
#7: Tetra-n-butylammonium acetate NnBu₄-OOC(CH₃) in solid form:
   A commercially available product (97%) from Aldrich was used.
#8: Diisobutylaluminum hydride iBu₂-AlH in the form of 1.0-molar solution:
   A ready-to-use, 1.0-molar solution in toluene was used (Aldrich).
#9: Lanthanocene Cp₃La in the form of 1.0-molar solution:
   Solid lanthanocene Cp₃La (99.9% from Aldrich) was dissolved in toluene to give a 1.0-molar solution. Cp is cyclopentadienyl.
#10: Methylaluminum bis(2,6-di-tert-butyl-4-methylphenolate) Me-Al-(BHT)₂ in the form of 1.0-molar solution:
   A ready-to-use, 1.0-molar solution in toluene was used (TCI interchim).
#11: Diethylaluminum chloride Et₂-Al—Cl in the form of 1.0-molar solution:
   A ready-to-use, 1.0-molar solution in toluene was used (Aldrich).
#12: Aluminum tri-n-butanolate (nBuO)₃-Al in the form of 1.0-molar solution:
   Solid aluminum tri-n-butanolate (nBuO)₃-Al (95% from Aldrich) was dissolved in toluene to give a 1.0-molar solution.
#13: sec-Butyllithium (sBuLi) in the form of 1.3-molar solution in toluene:
   A ready-to-use, 1.3-molar solution in toluene was used (Aldrich).

1c. Quaternary Phosphonium Compounds
ClPBu₄ drying:
ClPBu₄ was washed with methanol, and then residual amounts of water and methanol were removed by azeotropic distillation. The solid was washed with toluene, and solvent residues were removed by distillation in vacuo.
   2. Preparation of Polymers

All of the polymerization reactions were carried out in a glove box under nitrogen with exclusion of moisture. A round-bottomed flask with magnetic stirrer and a septum and temperature control was used. During the polymerization reaction, the mixture was stirred and the fall-off in monomer concentration was followed gravimetrically.

The molecular weights and molecular weight distributions in the resultant polymer mixture were determined by gel permeation chromatography (GPC) using tetrahydrofuran as eluent and polystyrene standards for calibration. The number-average molecular weight Mn and the weight-average molecular weight Mw were used to determine the polydispersity index PDI=Mw/Mn.

“Molar Al/N ratio” is the molar ratio of aluminum from the organoaluminum compound to ammonium-nitrogen from the ammonium compound.

2a. Preparation of PPO homopolymers H (Using Ammonium Salts)

### Inventive Example H1

11.7 ml of PO were added to 34.9 ml of cyclohexane. 0.1 g of solid NEt₄-OiPr (#4), and then 3.4 ml of the TIBA solution (#1), were added to the mixture, so that the molar Al/N ratio was 7.25:1. The mixture was polymerized at 0° C. for 60 minutes and then terminated via addition of 5 ml of ethanol. The results were as follows: conversion 100%, polydispersity index (PDI) 1.31, number-average molar mass Mn 19 800 g/mol.

### Inventive Example H2

9.7 ml of PO were added to 38.9 ml of cyclohexane. 0.017 g of solid NEt₄-OiPr (#4), and then 1.36 ml of the TIBA solution (#1), were added to the mixture, so that the molar Al/N ratio was 17.5:1. The mixture was polymerized at 0° C. for 3 hours and then terminated via addition of 5 ml of ethanol. The results were as follows: conversion 97%, polydispersity index (PDI) 1.4, number-average molar mass Mn 64 700 g/mol.

### Inventive Example H3

11.7 ml of PO were added to 34.9 ml of cyclohexane. 0.1 g of solid NEt₄-OiPr (#4), and then 3.4 ml of the TEA solution (#2), were added to the mixture, so that the molar Al/N ratio was 7.25:1. The mixture was polymerized at 0° C. for 16 hours and then terminated via addition of 5 ml of ethanol. The results were as follows: conversion 88%, polydispersity index (PDI) 1.6, number-average molar mass Mn 5300 g/mol.

### Inventive Example H4

12.3 ml of PO were added to 36.8 ml of cyclohexane. 0.179 g of solid NnBu₄-OiPr (#3), and then 0.88 ml of the TIBA solution (#1), were added to the mixture, so that the molar Al/N ratio was 1.45:1. The mixture was polymerized at 0° C. for 45 min and then terminated via addition of 5 ml of ethanol. The results were as follows: conversion 100%, polydispersity index (PDI) 1.2, number-average molar mass Mn 17 200 g/mol.

### Inventive Example H5

12.7 ml of PO were added to 35.5 ml of cyclohexane. 0.042 g of solid NnBu₄-OiPr (#3), and then 1.84 ml of the TIBA solution (#1), were added to the mixture, so that the molar Al/N ratio was 13.04:1. The mixture was polymerized at 0° C. for 60 min and then terminated via addition of 5 ml of ethanol. The results were as follows: conversion 96%, polydispersity index (PDI) 1.17, number-average molar mass Mn 78 700 g/mol.

### Inventive Example H6

8.1 ml of PO were added to 40.7 ml of cyclohexane. 0.011 g of solid NnBu₄-OiPr (#3), and then 1.17 ml of the TIBA solution (#1), were added to the mixture, so that the molar Al/N ratio was 31.16:1. The mixture was polymerized at 0° C. for 17 hours and then terminated via addition of 5 ml of ethanol. The results were as follows: conversion 100%, polydispersity index (PDI) 1.65, number-average molar mass Mn 86 900 g/mol.

### Inventive Example H7

12.3 ml of PO were added to 35.9 ml of cyclohexane. 0.179 g of solid NnBu₄-OiPr (#3), and then 1.76 ml of the TEA solution (#2), were added to the mixture, so that the molar Al/N ratio was 2.95:1. The mixture was polymerized at 0° C. for 2 hours and then terminated via addition of 5 ml of ethanol. The results were as follows: conversion 19%, polydispersity index (PDI) 1.21, number-average molar mass Mn 3200 g/mol.

### Inventive Example H8

12.3 ml of PO were added to 36.8 ml of cyclohexane. 0.026 g of solid NnBu₄-Cl (#5), and then 0.88 ml of the TIBA solution (#1), were added to the mixture, so that the molar Al/N ratio was 9.68:1. The mixture was polymerized at 0° C. for 45 min and then terminated via addition of 5 ml of ethanol. The results were as follows: conversion 98%, polydispersity index (PDI) 1.6, number-average molar mass Mn 86 600 g/mol.

### Inventive Example H9

12.3 ml of PO were added to 34.2 ml of cyclohexane. 0.125 g of solid NnBu₄-OH (#6), and then 3.5 ml of the TIBA solution (#1), were added to the mixture, so that the molar Al/N ratio was 7.2:1. The mixture was polymerized at 0° C. for 5 hours and then terminated via addition of 5 ml of ethanol. The results were as follows: conversion 56%, polydispersity index (PDI) 1.3, number-average molar mass Mn 19 000 g/mol.

### Inventive Example H10

12.6 ml of PO were added to 35.6 ml of cyclohexane. 0.141 g of solid NnBu₄-OOC(CH₃) (#7), and then 1.8 ml of the TIBA solution (#1), were added to the mixture, so that the molar Al/N ratio was 3.87:1. The mixture was polymerized at 0° C. for 60 min and then terminated via addition of 5 ml of ethanol. The results were as follows: conversion 91%, polydispersity index (PDI) 1.8, number-average molar mass Mn 52 100 g/mol.

In inventive examples H11 to H21 below, a coinitiator was used concomitantly. In all of the inventive examples except inventive example H21, the molar ratio of aluminum from the coinitiator to ammonium-nitrogen from the ammonium compound was 1:1. “Molar Al/N ratio” is as always the molar ratio of aluminum from the organoaluminum compound to ammonium-nitrogen from the ammonium compound.

### Inventive Example H11

0.134 g of solid NnBu₄-Cl (#5), and then 0.48 ml of the iBu₂-AlH solution as coinitiator (#8), were added to 37.4 ml of cyclohexane. 11.3 ml of PO and then 0.82 ml of the TIBA solution (#1) were then added to the mixture, the molar Al/N ratio therefore being 1.71:1. The mixture was polymerized at 0° C. for 30 min and then terminated via addition of 5 ml of ethanol. The results were as follows: conversion 98%, polydispersity index (PDI) 1.6, number-average molar mass Mn 23 100 g/mol.

### Comparative Example H12

Inventive example H11 was repeated, but no TIBA solution was added. The mixture was terminated after 4 hours at 0° C. Conversion was 0%.

### Comparative Example H13

Inventive example H11 was repeated, but no iBu₂-AlH solution was added, and, instead of the TIBA solution, a mixture of equal volumes of TIBA solution (#1) and Cp₃La solution (#9) was used. The mixture was terminated after 17 hours at 23° C. Conversion was 0%.

### Inventive Example H14

0.133 g of solid NnBu₄-Cl (#5), and then 0.48 ml of the Me-Al-(BHT)₂ solution as coinitiator (#10), were added to 37.5 ml of cyclohexane. 11.2 ml of PO and then 0.85 ml of the TEA solution (#2) were then added to the mixture, the molar Al/N ratio therefore being 1.8:1. The mixture was polymerized at 23° C. for 48 hours and then terminated via addition of 5 ml of ethanol. The results were as follows: conversion 24%, polydispersity index (PDI) 1.7, number-average molar mass Mn 4200 g/mol.

### Inventive Example H15

0.133 g of solid NnBu₄-Cl (#5), and then 0.48 ml of the Et₂-Al—Cl solution as coinitiator (#11), were added to 37.5 ml of cyclohexane. 11.2 ml of PO and then 0.85 ml of the TEA solution (#2) were then added to the mixture, the molar Al/N ratio therefore being 1.8:1. The mixture was polymerized at 23° C. for 24 hours and then terminated via addition of 5 ml of ethanol. The results were as follows: conversion 62%, polydispersity index (PDI) 1.7, number-average molar mass Mn 7500 g/mol.

### Comparative Example H16

Inventive example H11 was repeated, adding 0.82 ml of the Et₂-Al—Cl solution (#11) but no iBu₂-AlH solution and no TIBA solution. The mixture was terminated after 24 hours at 23° C. Conversion was 0%.

### Inventive Example H17

0.605 g of solid NnBu₄-Cl (#5), and then 2.2 ml of the Me-Al-(BHT)₂ solution as coinitiator (#10), were added to 38.4 ml of cyclohexane. 7.8 ml of PO and then 3.3 ml of the TIBA solution (#1) were then added to the mixture, so that the molar Al/N ratio was 1.5:1. The mixture was polymerized at 0° C. for 20 min and then terminated via addition of 5 ml of ethanol. The results were as follows: conversion 100%, polydispersity index (PDI) 1.5, number-average molar mass Mn 7000 g/mol.

### Inventive Example H18

0.132 g of solid NnBu₄-Cl (#5), and then 0.48 ml of the Me-Al-(BHT)₂ solution as coinitiator (#10), were added to 37.5 ml of cyclohexane. 11.2 ml of PO and then 0.8 ml of the TIBA solution (#1) were then added to the mixture, so that the molar Al/N ratio was 1.6:1. The mixture was polymerized at 0° C. for 20 min and then terminated via addition of 5 ml of ethanol. The results were as follows: conversion 72%, polydispersity index (PDI) 1.8, number-average molar mass Mn 31 800 g/mol.

### Inventive Example H19

0.647 g of solid NnBu₄-Cl (#5), and then 2.33 ml of the Et₂-Al—Cl solution as coinitiator (#11), were added to 39.3 ml of cyclohexane. 7.7 ml of PO and then 0.62 ml of the TIBA solution (#1) were then added to the mixture, so that the molar Al/N ratio was 0.27:1. The mixture was polymerized at 0° C. for 17 hours and then terminated via addition of 5 ml of ethanol. The results were as follows: conversion 29%, polydispersity index (PDI) 1.1, number-average molar mass Mn 600 g/mol.

### Inventive Example H20

0.134 g of solid NnBu₄-Cl (#5), and then 0.48 ml of the Et₂-Al—Cl solution as coinitiator (#11), were added to 37.5 ml of cyclohexane. 11.2 ml of PO and then 0.79 ml of the TIBA solution (#1) were then added to the mixture, so that the molar Al/N ratio was 1.6:1. The mixture was polymerized at 0° C. for 90 min and then terminated via addition of 5 ml of ethanol. The results were as follows: conversion 71%, polydispersity index (PDI) 1.5, number-average molar mass Mn 16 700 g/mol.

### Inventive Example H21

0.123 g of solid NnBu₄-Cl (#5), and then 1.6 ml of the (nBuO)₃-Al solution as coinitiator (#12), were added to 37.2 ml of cyclohexane. 10.5 ml of PO and then 0.74 ml of the TIBA solution (#1) were then added to the mixture, so that the molar Al_{organylaluminum compound}/N ratio was 1.6:1, and the molar Al_{coinitiator}/N ratio was 3.6:1. The mixture was polymerized at 0° C. for 4 hours and then terminated via addition of 5 ml of ethanol. The results were as follows: conversion 50%, polydispersity index (PDI) 1.4, number-average molar mass Mn 2000 g/mol.

### Comparative Example H22

Inventive example H11 was repeated adding 0.82 ml of the (nBuO)₃—Al solution (#12) but no iBu₂AlH solution and no TIBA solution. The mixture was terminated after 24 hours at 23° C. Conversion was 0%.

2b. Preparation of PPO Homopolymers H (Using Phosphonium Salts)

### Inventive Example H23

### TIBA/ClPBu₄ (1,3:1)

7 ml of toluene and 3 ml of PO (42.9 mmol) were added to 0.084 ml of a ClPBu₄ solution (0.2 M in toluene, 0.0168 mmol). 0.022 ml of a TIBA solution (1 M in hexane, Fluka) was added to the mixture (molar Al/P ratio=1.3). The fall-off in monomer concentration was followed gravimetrically at 0° C. After 1.5 hours, the reaction was terminated with 1 ml of ethanol. Conversion at that juncture was 74% by weight. GPC analysis of the resultant polymer mixture showed a polydispersity index (PDI) of Mw/Mn=1.10 with molar mass Mn=10 700 g/mol.

### Inventive Example H24

### TIBA/ClPBu₄ (1.53:1)

7 ml of toluene and 3 ml of PO (42.9 mmol) were added to 0.032 ml of a ClPBu₄ solution (0.2 M in toluene, 0.00635 mmol). 0.010 ml of a TIBA solution (1 M in hexane, Fluka) was added to the mixture (molar Al/P ratio=1.53). The fall-off in monomer concentration was followed gravimetrically at 0° C. After 1.5 hours, the reaction was terminated with 1 ml of ethanol. Conversion at that juncture was 48% by weight. GPC analysis of the resultant polymer mixture showed a polydispersity index of Mw/Mn=1.20 with molar mass Mn=18 200 g/mol.

### Inventive Example H25

### TIBA/ClPBu₄ (5:1)

7 ml of toluene and 3 ml of PO (42.9 mmol) were added to 0.019 ml of a ClPBu₄ solution (0.2 M in toluene, 0.00386 mmol). 0.020 ml of a TIBA solution (1 M in hexane, Fluka) was added to the mixture (molar Al/P ratio=5). The fall-off in monomer concentration was followed gravimetrically at 0° C. After 2 hours, the reaction was terminated with 1 ml of ethanol. Conversion at that juncture was 48% by weight. GPC analysis of the resultant polymer mixture showed a polydispersity index of Mw/Mn=1.20 with molar mass Mn=29 800 g/mol.

### Inventive Example H26

### TIBA/ClPBu₄ (1.1:1)

7 ml of toluene and 3 ml of PO (42.9 mmol) were added to 0.058 ml of a ClPBu₄ solution (0.2 M in toluene, 0.0116 mmol). 0.013 ml of a TIBA solution (1 M in hexane, Fluka) was added to the mixture (molar Al/P ratio=1.1). The fall-off in monomer concentration was followed gravimetrically at 0° C. After 6 hours, the reaction was terminated with 1 ml of ethanol. Conversion at that juncture was 50% by weight. GPC analysis of the resultant polymer mixture showed a polydispersity index of Mw/Mn=1.18 with molar mass Mn=12 300 g/mol.

### Inventive Example H27

### TIBA/ClPBu₄ (1.3:1)

7 ml of toluene and 3 ml of PO (42.9 mmol) were added to 0.085 ml of a ClPBu₄ solution (0.2 M in toluene, 0.0170 mmol). 0.023 ml of a TIBA solution (1 M in hexane, Fluka) was added to the mixture (molar Al/P ratio=1.3). The fall-off in monomer concentration was followed gravimetrically at 20° C. After one hour, the reaction was terminated with 1 ml of ethanol. Conversion at that juncture was 80% by weight. GPC analysis of the resultant polymer mixture showed a polydispersity index of Mw/Mn=1.30 with molar mass Mn=7800 g/mol.

### Inventive Example H28

### TIBA/ClPBu₄ (1.2:1)

7 ml of toluene and 3 ml of PO (42.9 mmol) were added to 0.058 ml of a ClPBu₄ solution (0.2 M in toluene, 0.0116 mmol). 0.014 ml of a TIBA solution (1 M in hexane, Fluka) was added to the mixture (molar Al/P ratio=1.2). The fall-off in monomer concentration was followed gravimetrically at 50° C. After 2 hours, the reaction was terminated with 1 ml of ethanol. Conversion at that juncture was 98% by weight. GPC analysis of the resultant polymer mixture showed a polydispersity index of Mw/Mn=1.32 with molar mass Mn=12 000 g/mol.

### Comparative Example H29

### TIBA/ClPBu₄ (0.88:1)

7 ml of toluene and 3 ml of PO (42.9 mmol) were added to 0.063 ml of a ClPBu₄ solution (0.2 M in toluene, 0.0125 mmol). 0.011 ml of a TIBA solution (1 M in hexane, Fluka) was added to the mixture (molar Al/P ratio=0.88). The fall-off in monomer concentration was followed gravimetrically at 50° C. After 24 hours, the reaction was terminated with 1 ml of ethanol. Conversion at that juncture was 0% by weight.

2c. Preparation of PO Block Copolymers C

### Inventive Example C1

a) 1.5 ml of styrene and 0.1 ml of the s-BuLi solution (#13) were added to 13.0 ml of cyclohexane. The mixture was polymerized at 0° C. for 60 min, and a specimen was then withdrawn. The results were as follows: conversion 100%, polydispersity index (PDI) 1.1, number-average molar mass Mn 12 500 g/mol. The polystyryllithium block PS-Li was probably present.

b) A solution of 0.0364 g of NnBu₄-Cl (#5) in 3 ml of PO was added to 14.0 ml of the orange-colored solution obtained in a). Once the mixture had become colorless, 0.6 ml of the TIBA solution (#1) was added to the mixture, so that the molar Al/N ratio was 5:1. The mixture was polymerized at 0° C. for 2.5 hours and then terminated via addition of 2 ml of ethanol. The results for the PS-PPO block copolymer obtained were as follows: conversion 97%, polydispersity index (PDI) 1.3, number-average molar mass Mn 17 700 g/mol.

### Inventive Example C2

a) 7.5 ml of styrene and 0.55 ml of the s-BuLi solution (#13) were added to 15.0 ml of cyclohexane. The mixture was polymerized at 0° C. for 60 min, and then 0.3 ml of PO and finally 5 drops of a mixture of equal volumes of water and conc. HCl were added. Once the mixture had become colorless, a specimen was withdrawn. The results were as follows: conversion 99.5%, polydispersity index (PDI) 1.1, number-average molar mass Mn 8900 g/mol. A polystyrene block having a terminal hydroxyl group PS-OH was probably present. The polymer was isolated conventionally.

b) 1.68 g of the polymer obtained in a) were dissolved in 13.0 ml of cyclohexane. 0.1 ml of the TIBA solution (#1) was added to the mixture, which was kept at 23° C. for 3 hours. A solution of 0.0275 g of NnBu₄-Cl (#5) in 4 ml of PO was then added, and the mixture was kept at 0° C. for 60 min. 1.2 ml of the TIBA solution (#1) were then added, so that the molar Al/N ratio was 6:1, and the mixture was polymerized at 0° C. for 2.5 hours. The mixture was then terminated with 2 ml of ethanol. The results for the PS-PPO block copolymer obtained were as follows: conversion 98%, polydispersity index (PDI) 1.3, number-average molar mass Mn 10 000 g/mol.

The examples show that the inventive process can easily prepare homo- but also copolymers of oxiranes. The polymerization times were considerably shorter and, respectively, the molecular weights Mn achieved were markedly higher than with the known processes: see by way of example inventive example H5, 78 700 after only 60 min; inventive example H8, 86 600 after only 45 min; and inventive example H18, 31 800 after only 20 min. This also applies to the copolymers, for example in inventive example C1 with Mn 17 700 after 60 min for the PS block and 2.5 hours for the PPO block.

1. A process for preparation of homopolymers composed of oxiranes, or of copolymers composed of oxiranes and comonomers, via anionic polymerization, which comprises carrying out a polymerization in the presence of a quaternary ammonium and/or phosphonium compound and of a mononuclear organylaluminum compound of the formula R₃—Al, where the radicals R are, independently of one another, hydrogen, halogen, C₁₋₂₀-alkyl, C₆₋₂₀-aryl, or C₇₋₂₀-arylalkyl.

2. The process according to claim 1, wherein the oxiranes have been selected from propylene oxide, ethylene oxide, and mixtures of these.

3. The process according to claim 1, wherein the comonomers have been selected from styrene, α-methylstyrene, butadiene, isoprene, and mixtures of these.

4. The process according to claim 1, wherein the quaternary ammonium or phosphonium compound has the formula NR₄—X or PR₄—X, where R is identical or different alkyl having from 1 to 10 carbon atoms, and X is halogen, OH, or an alcoholate radical having from 1 to 10 carbon atoms.

5. The process according to claim 1, wherein trialkylaluminum compounds are used as organylaluminum compound.

6. The process according to claim 1, wherein the molar ratio of organylaluminum compound to quaternary ammonium or phosphonium compound, calculated as aluminum atoms to nitrogen atoms or phosphorus atoms, is from 1.5:1 to 100:1.

7. The process according to claim 1, wherein the quaternary ammonium or phosphonium compound is added first and then the organylaluminum compound is added.

8. The process according to claim 1, wherein the copolymers are block copolymers, and sequential polymerization is first used to polymerize the comonomer to give a polymer block B, and then the oxirane is polymerized to give a polyoxirane block A.

9. The process according to claim 8, wherein concomitant use is made of an alkali metal compound during the polymerization of the polymer block B.

10. The process according to claim 1, wherein polymerization is carried out in the presence of a quaternary ammonium compound and of a mononuclear organylaluminum compound.

11. The process according to claim 2, wherein the comonomers have been selected from styrene, α-methylstyrene, butadiene, isoprene, and mixtures of these.

12. The process according to claim 2, wherein the quaternary ammonium or phosphonium compound has the formula NR₄—X or PR₄—X, where R is identical or different alkyl having from 1 to 10 carbon atoms, and X is halogen, OH, or an alcoholate radical having from 1 to 10 carbon atoms.

13. The process according to claim 3, wherein the quaternary ammonium or phosphonium compound has the formula NR₄—X or PR₄—X, where R is identical or different alkyl having from 1 to 10 carbon atoms, and X is halogen, OH, or an alcoholate radical having from 1 to 10 carbon atoms.

14. The process according to claim 2, wherein trialkylaluminum compounds are used as organylaluminum compound.

15. The process according to claim 3, wherein trialkylaluminum compounds are used as organylaluminum compound.

16. The process according to claim 4, wherein trialkylaluminum compounds are used as organylaluminum compound.

17. The process according to claim 2, wherein the molar ratio of organylaluminum compound to quaternary ammonium or phosphonium compound, calculated as aluminum atoms to nitrogen atoms or phosphorus atoms, is from 1.5:1 to 100:1.

18. The process according to claim 3, wherein the molar ratio of organylaluminum compound to quaternary ammonium or phosphonium compound, calculated as aluminum atoms to nitrogen atoms or phosphorus atoms, is from 1.5:1 to 100:1.

19. The process according to claim 4, wherein the molar ratio of organylaluminum compound to quaternary ammonium or phosphonium compound, calculated as aluminum atoms to nitrogen atoms or phosphorus atoms, is from 1.5:1 to 100:1.

20. The process according to claim 5, wherein the molar ratio of organylaluminum compound to quaternary ammonium or phosphonium compound, calculated as aluminum atoms to nitrogen atoms or phosphorus atoms, is from 1.5:1 to 100:1.
